(19) United States
(12) Patent Application Publication
(10) Pub. No.: US 2022/0337964 A1
(43) Pub. Date: Oct. 20, 2022

(54) Fitting Two Hearing Devices Simultaneously

(71) Applicant: SONOVA AG, Staefa (CH)

(72) Inventor: Manuela Feilner, Egg b. Zürich (CH)

(21) Appl. No.: 17/763,458

(22) PCT Filed: Oct. 8, 2019
(86) PCT No.: PCT/EP2019/077224

§ 371 Date: Mar. 24, 2022

(51) Int. Cl. H04R 25/00

(52) U.S. Cl. CPC H04R 25/70; H04R 25/554; H04R 2225/55

(57) ABSTRACT

An illustrative fitting system may be configured to connect a first hearing device worn by a first user and a second hearing device worn by a second user with a fitting device for data communication, read configuration and sound processing data from the first hearing device and the second hearing device into the fitting device, determine, with the fitting device and based on the configuration and sound processing data, first parameters for an audiological functionality performable by the first hearing device and second parameters for an audiological functionality performable by the second hearing device, and simultaneously send the first parameters from the fitting device to the first hearing device and the second parameters from the fitting device to the second hearing device.

### TECHNICAL FIELD

The invention relates to a method, a computer program and a computer-readable medium for fitting two hearing devices with one fitting device. Furthermore, the invention relates to a fitting system with two hearing devices and a fitting device.

### BACKGROUND

Hearing devices are generally small and complex devices. Hearing devices can include a processor, microphone, speaker, memory, housing, and other electronical and mechanical components. Some example hearing devices are Behind-The-Ear (BTE), Receiver-In-Canal (RIC), In-The-Ear (ITE), Completely-In-Canal (CIC), and Invisible-In-The-Canal (IIC) devices. A user can prefer one of these hearing devices compared to another device based on hearing loss, aesthetic preferences, lifestyle needs, and budget.

The customer journey of a hearing device wearer may often begin cumbersome by the awareness of having a problem with regard to hearing, followed by counselling and fitting because of this problem. This may cause the customer to procrastinate the start of this process. Furthermore, fine tuning of a hearing device may be difficult to perform by a hearing care professional.

WO2011/147998A2 describes a system for providing distant support to a plurality of personal hearing system users.

### DESCRIPTION OF THE INVENTION

It is an objective of the invention to simplify the tuning and fitting of hearing devices and/or to make the tuning more efficient.

This objective is achieved by the subject-matter of the independent claims. Further exemplary embodiments are evident from the dependent claims and the following description.

A first aspect of the invention relates to a method for fitting two hearing devices worn by two different users, i.e. a first hearing device worn by a first user and a second hearing device worn by a second user. A hearing device may be a device as described above. In the following everything what applies to the first hearing device also may apply to a pair of first hearing devices worn by the first user and everything what applies to the second hearing device also may apply to a pair of second hearing devices worn by the second user.

A hearing device may be a hearing aid adapted for compensating the hearing loss of a user.

A hearing device also may be a hearable. A hearable may be a headphone with additional features. A hearable may be used for mobile communication, but also may be used to compensate a mild hearing loss of a user. For example, the first hearing device may be a hearing aid and the second hearing device may be a hearable, or vice versa.

A hearing device may comprise a microphone, a sound processor and a sound output device, such as a loudspeaker. The sound processor may receive a sound signal from the microphone and may frequency dependent amplify and/or attenuate the sound signal. The sound signal then may be output by the sound output device, such as a loudspeaker, to the ear of the user.

According to an embodiment of the invention, the method comprises connecting a first hearing device worn by a first user and a second hearing device worn by a second user with a fitting device for data communication. A hearing device furthermore may comprise an interface for data communication with a partner device. The data communication may be performed wirelessly and/or may be automatically established. The fitting device may be a computing device, such as a PC, on which a fitting software adapted for tuning the first and second hearing device is run. The fitting device may comprise an interface for data communication with the hearing devices. It has to be noted that also (digital) audio data may be sent and/or received via data communication. In this context, data may refer to metadata and/or audio data.

The method as described herein may be performed automatically by the hearing devices and a fitting device in data communication with the hearing device.

According to an embodiment of the invention, the method further comprises: reading first configuration data and first sound processing parameterization data from the first hearing device into the fitting device and reading second configuration data and second sound processing parameterization data from the second hearing device into the fitting device. The respective configuration data may comprise information about the type of the hearing device and/or the software installed in the hearing device. The respective configuration data may also comprise personal data (such as name and/or birth date of the user), logging of usage, such as a duration, etc. The respective sound processing parameterization data may comprise information about settings with respect to the sound procession of the hearing device, such as performed by the sound processor mentioned above. The sound processing parameterization data may comprise a fitting curve of the user of the respective hearing device, which is adapted for compensating a hearing loss of the user.

The configuration data and the sound processing parameterization data is read out of the hearing devices and received in the fitting device.

According to an embodiment of the invention, the method further comprises determining, with the fitting device, first parameters for an audiological functionality performable by the first hearing device dependent on the first configuration data and the first sound processing parameterization data and determining, with the fitting device, second parameters for the audiological functionality performable by the second hearing device dependent on the second configuration data and the second sound processing parameterization data.

The audiological functionality may relate to the sound processing of the hearing device, such as frequency and/or gain dependent attenuation of a sound signal, etc. The audiological functionality may be performed by a software module, which is stored and executed in the respective hearing device. It has to be noted that the first and second hearing devices may be different, i.e. of different type, and/or different type of software is stored in the respective hearing device for performing the same audiological functionality.

The audiological functionality may be tuned, selected and/or set with the fitting software executed in the fitting device. For example, a hearing care specialist may adapt the audiological functionality according to a need of a first user of the first hearing device and/or a second user of the second hearing device.

The first and second parameters may contain information of how sound should be processed in the hearing device with respect to specific situations. The first and second parameters may comprise an adapted fitting curve for the respective user of the respective hearing device. The first and second parameters may comprise adapted configuration data for a respective software module stored in the respective hearing device.

According to an embodiment of the invention, the method further comprises sending the first parameters from the fitting device to the first hearing device and applying the first parameters to the first hearing device, such that the first hearing device performs the audiological functionality and simultaneously sending the second parameters from the fitting device to the second hearing device and applying the second parameters to the second hearing device, such that the second hearing device performs the same audiological functionality.

In such a way, two different hearing devices may be fitted and/or tuned simultaneously. It may be faster and more efficient to fit two users simultaneously. It may be that at least two hearing device users, such as a couple, a grandfather with a grandchild, and in particular a hearing impaired person and a reference person, go together through the fitting and/or tuning process simultaneously with each of them following a different goal, e.g. to better conversate with each other also in loud restaurants, to suppress loud noise while being in a loud environment, to better hear under certain conditions, to stream music with good quality while commuting, etc.

The term “simultaneously” may be understood in such a way, that the sending and/or application of the parameters is performed directly one after the other and/or within a short time interval (such as less than 1 second), which may not be interrupted by a user interaction.

The method also may be performed for normal hearing device users, who want to configure a hearable and/or who want to use joint functions, such as a streaming of a voice signal from one of the hearing devices to the other. The whole process may be independent of the degree of hearing loss, only a suggestion of a hearing care specialist for the optimal hearing device may depend on the hearing and usage needs of the users.

According to an embodiment of the invention, the audiological functionality compensates a hearing loss of a user of the first hearing device and/or the second hearing device. As already mentioned, the first parameters and/or the second parameters may contain parameters adapting the sound processing of the hearing device, the first parameters and/or the second parameters may contain fitting curves defining a frequency and/or gain dependent attenuation of sound signals in the hearing device. The first parameters and/or the second parameters may contain parameters adjusting beam formers of the respective hearing device.

According to an embodiment of the invention, the audiological functionality is performed by a first audiological program in the first hearing device and by a second audiological program in the second hearing device. The audiological programs may be software modules stored and/or executed in the respective hearing device. These software modules may be uploaded to the respective hearing device by the fitting device.

According to an embodiment of the invention, before applying the first and second parameters, the first audiological program is sent from the fitting device to the first hearing device and simultaneously the second audiological program is sent from the fitting device to the second hearing device. In such a way, the two users may try simultaneously the same audiological functionality.

It also may be that the simultaneously fitting method is used for adjusting and/or tuning an audio stream of paired hearing devices with each other or with a further partner device, such as a microphone. Both hearing devices may be adapted to establish and/or connect to a wireless network, such as Bluetooth™ and another wireless network protocol. The hearing devices may be used as headsets which pick-up the user's voice with their integrated microphones and make the communication participant's voice audible via the integrated speaker of the respective hearing device.

According to an embodiment of the invention, the first configuration data and the second configuration data comprise pairing information for connecting the first hearing device and the second hearing device with a partner device. The partner device may be the other hearing device, a smartphone and/or a microphone, which is also adapted for establish data communication via the data communication network. Pairing information may contain data, such as a password, and/or configuration data for configuring an interface to connect to the network.

According to an embodiment of the invention, the fitting device prepares and/or determines first pairing parameters for the first hearing device from the pairing information and sends the first pairing parameters to the first hearing device, such that the first hearing device is adapted for automatically connect to an auxiliary device as partner device, such as a microphone or smartphone. In such a way, with the fitting software a user of a hearing device may be supported by connecting his or her hearing device with a partner device. This support may be provided by a hearing care specialist.

Analogously, the fitting device may prepare and/or determine second pairing parameters for the second hearing device from the pairing information and may send the second pairing parameters to the second hearing device, such that the second hearing device is adapted for automatically connect to the auxiliary device as partner device.

According to an embodiment of the invention, the first hearing device and the second hearing device are adapted for wireless data communication with each other, such that a voice of a first user, which may carry the first hearing device, is picked up with a microphone of the first hearing device, sent to the second hearing device and provided to a second user, which may carry the second hearing device, by the second hearing device with the audiological functionality applied. Both hearing devices may have interfaces (a sender/receiver) for wireless data communication, for example via Bluetooth or. When the hearing devices are paired, audiological functionality may be automatically started, which performs the above described voice pick up and transmit to the other hearing device.

According to an embodiment of the invention, the fitting device prepares and/or determines first pairing parameters for the first hearing device from the pairing information and sends the first pairing parameters to the first hearing device, such that the first hearing device is adapted for automatically connect to the second hearing device as partner device. Analogously, the fitting device may prepare and/or determine second pairing parameters for the second hearing device from the pairing information and sends the second pairing parameters to the second hearing device, such that the second hearing device is adapted for automatically connect to the first hearing device as partner device. The first and second parameters may encode that the pairing is automatically performed, when the two hearing devices detect each other and/or that the voice pick up and transmit functionality is automatically started, when the two hearing devices are paired.

According to an embodiment of the invention, wireless data communication between the first and/or the second hearing device with the fitting device at least partially takes place via the same communication network as data communication between the first hearing device and/or the second hearing device with the partner device.

The communication network may be a wireless communication network, such as Bluetooth and/or any other wireless communication protocol. It may be that also the fitting as described herein and in particular the download of configuration data and sound processing parameterization data from the hearing device to the fitting device as well as the upload of parameters from the fitting device to the respective hearing device is performed with the same communication channel and/or network as which is used for pairing the hearing devices with each other and/or with a further partner device.

According to an embodiment of the invention, a pairing related audiological functionality of the first and/or second hearing device relates to receiving and processing a sound signal from the partner device when the partner device is connected with the first and/or second hearing device. Such a pairing related audiological functionality may be the voice pick up and transmit functionality described above.

The first and/or second parameters may be determined by the fitting device, such that the pairing related audiological functionality of the first and/or second hearing device is automatically activated, when the partner device connects with the first and/or second hearing device. The first and second parameters may encode this behavior.

According to an embodiment of the invention, data communication between the first hearing device and the fitting device takes place via a mobile device, which is connected via Internet with the fitting device. Analogously, data communication between the second hearing device and the fitting device may take place via the same mobile device or a further mobile device, which is connected via Internet with the fitting device. In such a way, a remote simultaneous fitting may be performed, for example in an environment, where specific needs have to be met, such as in front of a television or in a restaurant.

Further aspects of the invention relate to a computer program for fitting two hearing devices, which, when being executed by a processor, is adapted to carry out the steps of the method as described in the above and in the following as well as to a computer-readable medium, in which such a computer program is stored.

For example, the computer program may be executed in a processor of the fitting device. The computer-readable medium may be a memory of the fitting device. It also may be that steps of the method are performed by the hearing devices and other steps of the method are performed by the fitting device.

In general, a computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. A computer-readable medium may also be a data communication network, e.g. the Internet, which allows downloading a program code. The computer-readable medium may be a non-transitory or transitory medium.

A further aspect of the invention relates to a fitting system comprising a fitting device and two hearing devices, wherein the fitting system is adapted for performing the method as described in the above and the below. The fitting system may additionally comprise at least one mobile device for communicatively interconnecting the first hearing device and the second hearing device with the fitting device.

It has to be understood that features of the method as described in the above and in the following may be features of the computer program, the computer-readable medium and the fitting system as described in the above and in the following, and vice versa.

These and other aspects of the invention will be apparent from and elucidated with reference to the embodiments described hereinafter.

### BRIEF DESCRIPTION OF THE DRAWINGS

Below, embodiments of the present invention are described in more detail with reference to the attached drawings.

FIG. 1 schematically shows a fitting system according to an embodiment of the invention.

FIG. 2 schematically shows a fitting system according to a further embodiment of the invention.

FIG. 3 schematically shows components of a fitting system according to a further embodiment of the invention.

FIG. 4 shows a flow diagram for a method for fitting two hearing devices according to an embodiment of the invention.

The reference symbols used in the drawings, and their meanings, are listed in summary form in the list of reference symbols. In principle, identical parts are provided with the same reference symbols in the figures.

### DETAILED DESCRIPTION OF EXEMPLARY EMBODIMENTS

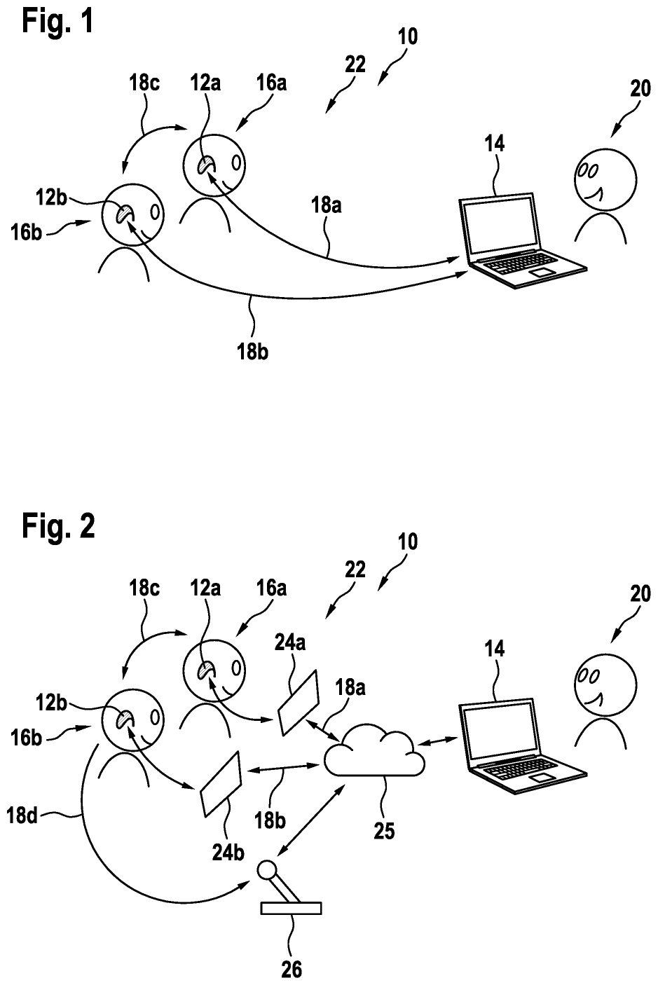

FIG. 1 shows a fitting system 10 comprising a first hearing device 12a and a second hearing device 12b as well as a fitting device 14. The hearing device 12a is worn by a first user 16a and the second hearing device 12b is worn by a second user 16b. For example, the hearing devices 12a, 12b may be hearing aids and/or hearables. One or both of the hearing devices 12a, 12b may be composed of a pair of ear devices, each of which is intended for one ear of the respective user 16a, 16b. The first user 16a may wear a first pair of hearing devices 12a and the second user 16b may wear a second pair of hearing devices 12b.

Both hearing devices 12a, 12b are connected via communication channels 18a, 18b with the fitting device 14, which is used for adjusting a configuration (i.e. a fitting) of the hearing devices 12a, 12b. The fitting device 14, which may be a PC, is operated by a hearing care specialist 20.

Each of the hearing devices 12a, 12b may be adapted for establishing data communication with other devices and/or may establish a wireless communication network 22, such as a Bluetooth network. The communication channels 18a, 18b may be generated in this way. It also may be possible that the two hearing devices 12a, 12b establish a communication channel 18c between each other in such a way.

As shown in FIG. 1, the hearing devices 12a, 12b may be directly linked with the fitting device 14. For example, this may be done in an office of the hearing care specials 20.

FIG. 2 shows a further embodiment, in which the two users 16a, 16b may be remote from the hearing care specialist 20 and his office. In this embodiment, each of the hearing devices 12a, 12b is connected to a mobile device 24a, 24b, which is connected via the Internet 23 or WLAN with the fitting device 14. The hearing devices 12a, 12b may be connected via Bluetooth and/or any other wireless data communication protocol to the mobile devices 24a, 24b, which may be smartphones and/or tablet computers.

FIG. 2 additionally shows a table microphone 25, which also may connect to a wireless network 22, which is established by the two hearing devices 12a, 12b. It may be that a data communication channel 18d is established between one or both of the hearing devices 12a, 12b and the table microphone 25. It also may be that the table microphone is connected to the fitting device 14, for example via Internet 23 or WLAN.

With the fitting system 10, a fitting and support functionality can be provided to the two users 16a, 16b simultaneously. The fitting device 14 may execute a fitting software, which may handle the two users 16a, 16b at the same time, for example by opening a specific mode.

For example, in FIG. 1, the two users 16a, 16b may be at the same time at the office of the hearing care specialist 20. The fitting software run by the fitting device 14 may fit the hearing devices 12a, 12b of the two users 16a, 16b at the same time. The fitting device 14 may connect via Bluetooth to the hearing devices 12a, 12b. The fitting software may inspect the two fittings of the two users 16a, 16b simultaneously and may read out the data of the hearing devices 12a, 12b. This data may comprise configuration data and sound processing parameterization data of the respective hearing device 12a, 12b.

Alternatively, as shown in FIG. 2, each hearing device 12a, 12b may connect to a mobile device 24a, 24b, for example via Bluetooth. The mobile devices 24a, 24b may be connected to the fitting device 14 with the fitting software of the hearing care specialist 20. The hearing care specialist 20 may remotely inspect the fittings of the two hearing devices 12a, 12b at the same time and may adapt the fitting jointly. Also, the two users 16a, 16b need not to be at the same place. An advantage of remote fitting may be that both users 16a, 16b want to solve an issue being at the same place, but do not need to go physically to the office of the hearing care specialist 20.

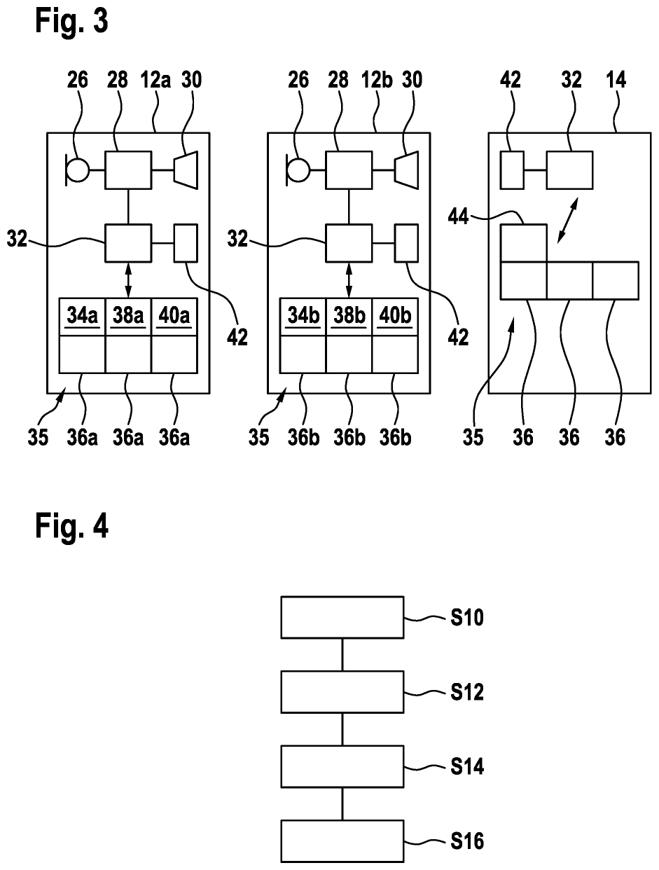

FIG. 3 shows a diagram illustrating components of the hearing devices 12a, 12b and the fitting device 14.

Each hearing device 12a, 12b may comprise a microphone 26, a sound processor 28 and a sound output device 30, such as a loudspeaker or so-called receiver. The microphone 26 may acquire environmental sound of the user 16a, 16b and may generate a sound signal, the sound processor 28 may amplify the sound signal and the sound output device 30 may generate sound provided to the respective user 16a, 16b.

Each hearing device 12a, 12b may comprise a processor 32, which is adapted for adjusting parameters of the sound processor 28. In particular, sound processing parameterization data 34a, 34b, such as fitting curves, may be stored in a memory of the respective hearing device 12a, 12b.

The audiological functionality of the respective hearing device 12a, 12b may be implemented as computer programs and/or software modules 36a, 36b stored in the memory 35 of the hearing device 12a, 12b, which software modules 36a, 36b may be executed by the processor 32. The audiological functionality may be parameterized with parameters 38a, 38b stored in the respective memory 35 of the hearing device 12a, 12b. Furthermore, configuration data 40a, 40b, for example indicating a type of hearing device and/or software modules presented in the hearing device, may be stored in the hearing device 12a, 12b.

Every hearing device 12a, 12b furthermore may comprise a sender/receiver and/or interface 42 for wireless data communication, the communication channels 18a, 18b, 18c and/or the wireless network 22 may be established via these interfaces 42.

The fitting device 14, which may be a PC, also may comprise such a sender/receiver and/or interface 42 for wireless data communication. A processor 32 of the fitting device 14 may execute a fitting software 44 stored in a memory 35 of the fitting device 14. Furthermore, the fitting device 14 may store software modules 36, which may be uploaded to the hearing devices 12a, 12b, as described below.

FIG. 4 shows a flow diagram for a method for simultaneously fitting two hearing devices 12a, 12b that may be performed with the fitting system 10. All parts of the method performed by the fitting device 14 may be performed by the fitting software 44.

In step S10, the first hearing device 12a and the second hearing device 12b are connected with the fitting device 14 for data communication. For example, the hearing devices 12a, 12b are in proximity to the fitting device 14, the fitting device 14 may recognize the two hearing devices 12a, 12b as present, and the communication channels 18a, 18b may be established directly by the fitting device 14, such as shown in FIG. 1.

It also may be that the hearing devices 12a, 12b are already connected to one or two mobile devices 24, 24b. The fitting device 14 then may be connected via Internet 23, for example with the aid of an application run in the one or two mobile devices 24, 24b.

When the fitting device 14 is connected, the fitting device 14 reads the first configuration data 40a and the first sound processing parameterization data 34a from the first hearing device 12a and the second configuration data 40b and the second sound processing parameterization data 34b from the second hearing device 12b into the fitting device 14. Form this data, the fitting device 14 can determine the types of hearing devices connected, their configuration, such as presently installed programs and/or modules 36a, 36b and/or the actual sound processing settings, such as fitting curves.

The fitting device 14 and/or the fitting software 44, which performs the functionality of the fitting device 14 as described herein, may comprise a user interface, which displays the collected information to the hearing care specialist 20. The hearing care specialist 20 can inspect the two hearing devices 12a, 12b and their fitting and can compare them. After that, the hearing care specialist 20 can adapt specific audiological functionality of both hearing devices 12a, 12b and can select new audiological functionality, he or she wants to present the two users 16a, 16b. It also may be possible that the desired adaption or selection of audiological functionality was defined before and that the fitting software 44 continues immediately with the following steps.

In step S12, the fitting device 14 determines first parameters 38a for an audiological functionality performable by the first hearing device 12a dependent on the first configuration data 40a and the first sound processing parameterization data 34b. Additionally, the fitting device 14 determines second parameters 38b for the audiological functionality performable by the second hearing device 12b dependent on the second configuration data 40b and the second sound processing parameterization data 34b.

For example, the audiological functionality may be a beam former program, a program for TV listening, etc. the audiological functionality may be performed by one or more of the software modules 36a, 36b stored in the hearing devices 12a, 12b.

One example for an audiological functionality is the pairing of the two hearing devices 12a, 12b with each other or with a further auxiliary device 26. For example, a pairing related audiological functionality of the first hearing device 12a and/or second hearing device 12b may relate to receiving and processing a sound signal from the other hearing device 12a, 12b, when the hearing devices 12a, 12b are connected with each other. This sound signal may be a voice signal of the user 16a, 16b of the other hearing device 12a, 12b.

The fitting device 14 may check compatibility of the two hearing devices 12a, 12b in view of pairing and/or may be used by the hearing care specialist 20 to solve issues to use a communication network 22, such as Proxicom, Bluetooth, etc., in this context.

For example, it may be that the two users 167a, 16b, such as an elderly couple who are both hearing impaired, want to use their hearing devices 12a, 12b with each other. They tried to activate and use this function at home, but failed. At his office, the hearing care specialist then may connect the two hearing devices 12a, 12b simultaneously to the fitting device 14. For example, in a simultaneous mode, the compatibility of the two hearing devices 12a, 12b can be checked with regard to all functionality, such as Proxicom. If the two hearing devices 12a, 12b are compatible, the hearing care specialist 20 may pair the two hearing devices 12a, 12b, by commanding the fitting device 14 accordingly.

For example, to use Proxicom or another communication network 22, the hearing devices 12a, 12b may need to give rights and access to each other to be able to offer and request respectively their own microphone signal over Bluetooth or a similar protocol. To not suffer of misuse this intention, a secure pairing may have to be performed, which allows those two hearing devices 12a, 12b to have access to each other. During the pairing process, a secure key may be exchanged and stored in both hearing devices 12a, 12b. Such a secure key may be included in the first and second parameters 38a, 38b.

Since the process of pairing may be a difficult task for the users 16a, 16b, the pairing process may be performed by the hearing care specialist 20 during a simultaneous fitting process, which may be provided with the method described herein.

In summary, the first configuration data 40a and the second configuration data 40b may comprise pairing information for connecting the first hearing device 12a and the second hearing device 12b with a partner device 12a, 12b, 26. This pairing information may comprise a secure key, identifiers of the devices 12a, 12b, 26 and/or information about the useable communication channels, such as a data rate, etc.

The fitting device 14 may prepare first pairing parameters for the first hearing device 12a from the pairing information and sends the first pairing parameters to the first hearing device 12a, such that the first hearing device 12a is adapted for automatically connect to the second hearing device 12b as partner device. Also, the fitting device 14 may prepare second pairing parameters for the second hearing device 12b from the pairing information and sends the second pairing parameters to the second hearing device 12b, such that the second hearing device 12b is adapted for automatically connect to the first hearing device 12a as partner device.

The first pairing parameters may be part of the first parameters 38a and the second pairing parameters may be part of the second parameters 38a. The first pairing parameters and the second pairing parameters may include information from the first configuration data 40a and the second configuration data 40b, such as the secure key, the identifiers of the devices 12a, 12b, 26 and/or information about the useable communication channels, such as a data rate, etc.

It may be that the first and/or second pairing parameters are determined by the fitting device 14, such that the pairing related audiological functionality of the first hearing device 12a and/or second hearing device 12b is automatically activated, when the hearing devices 12a, 12b connect with each other.

It also may be that the users 16a, 16b were successful in pairing their hearing devices 12a, 12b, but are not satisfied with the result. For example, it is known that some voices, which are streamed, are very unpleasant to listen to. It is also known that some voices are more difficult to understand than others. This may also depend on the individual hearing loss. In the present case of the two paired hearing devices 12a, 12b, the voice, which is arriving from the other paired hearing device 12a, 12b, may be always the same (e.g. the one of the spouse). Therefore, this voice can be adapted to the user 16a, 16b at the receiving side. This may improve speech intelligibility by fine tuning this particular voice and/or adaptation and individualization of frequency compression. This may also improve comfort by fine tuning this particular voice and applying loudness adaptations.

The first and second pairing parameters may comprise parameters on adaptation and/or individualization of the sound processing of the hearing devices 12a, 12b, when receiving a voice signal from the paired other hearing device 12a, 12b.

It also may be that an ambient balancing is adjusted for the pairing. Ambient balancing is a function, which controls the attenuation among different audio sources streamed to a hearing device 12a, 12b. An amount of microphone attenuation may be individualized for each streaming input, such as from an auxiliary microphone and/or a TV connector.

However, if the microphone input (also known as “ambient”) is attenuated too much during the use of the pairing of the two hearing devices 12a, 12b, the users 16a, 16b may not hear other noises or other individuals around themselves. If the microphone input is not attenuated, the signal-to-noise ratio may be too low, i.e. the intelligibility of the streamed input may be decreased in an acoustically loud environment.

With the method, ambient balancing may be optimized for the two users 16a, 16b jointly, in particular dependent in which scenario they want to use the pairing. It also may be that the users 16a, 16b may want to have more than one pairing program, each one adapted to a particular scenario, such as restaurant or car driving.

For example, for a car driving program, the driver may need to have less ambient attenuation, since he needs to hear car functionalities and the street environment. The co-driver may have the full ambient suppression for best speech intelligibility and best comfort (car noise may be suppressed as well).

As a second example, for a restaurant program, the user who has the more severe hearing loss may have the setting with the maximum of ambient attenuation, the user with better hearing may have very limited ambient attenuation to understand the waitress and other people approaching their table.

The first pairing parameters and the second pairing parameters may comprise information on attenuating a plurality of sound signals received in the hearing devices 12a, 12b, when the two hearing devices 12a, 12b are paired.

It is also possible that the hearing devices 12a, 12b are additionally or alternatively paired with an auxiliary device 26.

For example, the hearing devices 12a, 12b may be paired with a table microphone 26. A table microphone 26 may be useful to be incorporated into a communication network 22.

A pre-configuration may help the users 16a, 16b to setup such a communication network 22 quickly. This may be performed by an audiological program, which launches the connection to all other already paired hearing devices 12a, 12b.

This all may be included into first and second pairing parameters, such as a secure key, an identifier and/or configuration parameters of the auxiliary device 26.

The fitting device 14 may prepare first pairing parameters for the first hearing device 12a from the pairing information and sends the first pairing parameters to the first hearing device 12a, such that the first hearing device 12a is adapted for automatically connect to an auxiliary device 26 as partner device. The fitting device 14 also may prepare second pairing parameters for the second hearing device 12b from the pairing information and sends the second pairing parameters to the second hearing device 12b, such that the second hearing device 12b is adapted for automatically connect to the auxiliary device 26 as partner device.

In step S14, before applying the first parameters 38a and second parameters 38b, the fitting device 14 may check, whether the programs or modules 36a, 36b are already present in the hearing devices 12a, 12b, which are adapted for performing the audiological functionality as commanded by the first parameters 38a and second parameters 38b.

Different audiological programs 36, 36a, 36b may be defined and optimized for a specific scenario, e.g. improvement of speech intelligibility in a restaurant, noise reduction while working in an open office, streaming phone calls, using Proxicom with a specific individual, using Proxicom with anybody/with a group.

A set of programs and/or modules 36 for different types and/or configuration of hearing devices 12a, 12b may be stored in the fitting device 14. From this set, the respective program and/or module 36 may be selected and installed in the respective hearing device 12a, 12b.

A first audiological program 36a may be sent from the fitting device 14 to the first hearing device 12a and simultaneously a second audiological program 36b may be sent from the fitting device 14 to the second hearing device 12b.

In step S16, the fitting device sends the first parameters 38a to the first hearing device 12a and the first parameters 38a are applied to the first hearing device 12a, such that the first hearing device 12a performs the audiological functionality. Simultaneously, the fitting device sends the second parameters 38b to the second hearing device 12b and the second parameters 38b are applied to the second hearing device 12b, such that the second hearing device 12b performs the audiological functionality.

As already mentioned, the audiological functionality may compensate a hearing loss of the user 16a, 16b of the first hearing device 12a and/or the second hearing device 12b. The audiological functionality may be performed by a first audiological program 36a in the first hearing device 12a and by a second audiological program 36b in the second hearing device 12b.

For example, in the case, the two hearing devices 12a, 12b are paired with each other, audiological programs 36a, 36b may be performed, such that the first hearing device 12a and the second hearing device 12b are adapted for wireless data communication with each other and that in particular a voice of the first user 16a (and/or second user 16b) is picked up with a microphone 26 of the first hearing device 12a (and/or second hearing device 12b), sent to the second hearing device 12b (and/or first hearing device 12a) and provided to a second user 16b (and/or first user 16a) by the second hearing device 12b and/or first hearing device 12a) with the audiological functionality applied.

In the case, the two hearing devices 12a, 12b are paired with the auxiliary device 26, such as a table microphone, audiological programs 36a, 36b may be performed, such that the first hearing device 12a and the second hearing device 12b are adapted for wireless data communication with the auxiliary device 26. A sound signal from the auxiliary device 26 may be sent to the first hearing device 12a and the second hearing device 12b. The sound signal may be provided to the first users 16a and the second user 16b by the respective first and second hearing device 12a, 12b with the audiological functionality applied. The audiological programs 36a, 36b may be adapted for ambient balancing and attenuating the voice signal from the other user and the sound signal from the auxiliary device 26 accordingly.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practising the claimed invention, from a study of the drawings, the disclosure, and the appended claims. In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

### LIST OF REFERENCE SYMBOLS

10 fitting system
12a first hearing device
12b second hearing device
14 fitting device
16a first user
16b second user
18a communication channel
18b communication channel
18c communication channel
18d communication channel
20 hearing care specialist
22 wireless communication network
23 Internet
24a first mobile device
24b second mobile device
25 table microphone
26 microphone
28 sound processor
30 sound output device
32 processor
34a first parameterization data
34b first parameterization data
35 memory
36 software module
36a software module
36b software module
38a first parameters
38b second parameters
40a first configuration data
40b second configuration data
42 sender/receiver/interface
44 fitting software

1. A method for fitting two hearing devices (12a, 12b), the method comprising:
connecting a first hearing device (12a) worn by a first user (16a) and a second hearing device (12b) worn by a second user 16b) with a fitting device (14) for data communication;
reading first configuration data (40a) and first sound processing parameterization data (34a) from the first hearing device (12a) into the fitting device (14);
reading second configuration data (40b) and second sound processing parameterization data (34b) from the second hearing device (12b) into the fitting device (14);
determining, with the fitting device (14), first parameters (38a) for an audiological functionality performable by the first hearing device (12a) dependent on the first configuration data (40a) and the first sound processing parameterization data (34b);
determining, with the fitting device (14), second parameters (38b) for the audiological functionality performable by the second hearing device (12b) dependent on the second configuration data (40b) and the second sound processing parameterization data (34b);
sending the first parameters (38a) from the fitting device (14) to the first hearing device (12a) and applying the first parameters (38a) to the first hearing device (12a), such that the first hearing device (12a) performs the audiological functionality;
simultaneously sending the second parameters (38b) from the fitting device (14) to the second hearing device (12b) and applying the second parameters (38b) to the second hearing device (12b), such that the second hearing device (12b) performs the audiological functionality.

2. The method of claim 1,
wherein the audiological functionality compensates a hearing loss of a user of the first hearing device (12a) and/or the second hearing device (12b).

3. The method of claim 1 or 2,
wherein the audiological functionality is performed by a first audiological program (36a) in the first hearing device (12a) and by a second audiological program (36b) in the second hearing device (12b);
wherein, before applying the first parameters (38a) and second parameters (38b), the first audiological program (36a) is sent from the fitting device (14) to the first hearing device (12a) and simultaneously the second audiological program (36b) is sent from the fitting device (14) to the second hearing device (12b).

4. The method of one of the previous claims,
wherein the first configuration data (40a) and the second configuration data (40b) comprises pairing information for connecting the first hearing device (12a) and the second hearing device (12b) with a partner device (12a, 12b, 26).

5. The method of claim 4,
wherein the fitting device (14) prepares first pairing parameters for the first hearing device (12a) from the pairing information and sends the first pairing parameters to the first hearing device (12a), such that the first hearing device (12a) is adapted for automatically connect to an auxiliary device (26) as partner device;
wherein the fitting device (14) prepares second pairing parameters for the second hearing device (12b) from the pairing information and sends the second pairing parameters to the second hearing device (12b), such that the second hearing device (12b) is adapted for automatically connect to the auxiliary device (26) as partner device.

6. The method of claim 4 or 5,
wherein the first hearing device (12a) and the second hearing device (12b) are adapted for wireless data communication with each other, such that a voice of a first user (16a) is picked up with a microphone (26) of the first hearing device (12a), sent to the second hearing device (12b) and provided to a second user (16a) by the second hearing device (12b) with the audiological functionality applied.

7. The method of claim 6,
wherein the fitting device (14) prepares first pairing parameters for the first hearing device (12a) from the pairing information and sends the first pairing parameters to the first hearing device (12a), such that the first hearing device (12a) is adapted for automatically connect to the second hearing device (12b) as partner device;
wherein the fitting device (14) prepares second pairing parameters for the second hearing device (12b) from the pairing information and sends the second pairing parameters to the second hearing device (12b), such that the second hearing device (12b) is adapted for automatically connect to the first hearing device (12a) as partner device.

8. The method of one of claims 4 to 7,
wherein wireless data communication between the first hearing device (12a) and/or the second hearing device (12b) with the fitting device (14) at least partially takes place via the same communication network (22) as data communication between the first hearing device (12) and/or the second hearing device (12b) with the partner device (12a, 12b, 26).

9. The method of one of claims 4 to 7,
wherein a pairing related audiological functionality of the first hearing device (12a) and/or second hearing device (12b) relates to receiving and processing a sound signal from the partner device (12a, 12b, 26), when the partner device is connected with the first hearing device (12a) and/or second hearing device (12b);
wherein the first and/or second parameters are determined by the fitting device (14), such that the pairing related audiological functionality of the first hearing device (12a) and/or second hearing device (12b) is automatically activated, when the partner device connects with the first hearing device (12a) and/or second hearing device (12b).

10. The method of one of the previous claims,
wherein data communication between the first hearing device (12a) and the fitting device (14) takes place via a mobile device (24a), which is connected via Internet (23) with the fitting device (14); and/or
wherein data communication between the second hearing device (12b) and the fitting device (14) takes place via the mobile device (24a) or a further mobile device (24b), which is connected via Internet (23) with the fitting device (14).

11. The method of one of the previous claims,
wherein the first hearing device (12a) or the second hearing device (12b) is a hearing aid;
wherein the second hearing device (12b) or the first hearing device (12a) is a hearable.

12. A computer program (44) for fitting two hearing devices (12a, 12b), which, when being executed by a processor, is adapted to carry out the steps of the method of one of the previous claims.

13. A computer-readable medium (35), in which a computer program (44) according to claim 12 is stored.

14. A fitting system (10) comprising a fitting device (14) and two hearing devices (12a, 12b),
wherein the fitting system (10) is adapted for performing the method of one of claims 1 to 11.

15. The fitting system (10) of claim 14, further comprising:
at least one mobile device (24a, 24b) for communicatively interconnecting the first hearing device (12a) and the second hearing device (12b) with the fitting device (14).
